(19) United States
(12) Patent Application Publication
(10) Pub. No.: US 2016/0160782 A1
(43) Pub. Date: Jun. 9, 2016

(54) METHOD OF DIAGNOSING ELECTRONIC WATER PUMP OF ENGINE

(71) Applicants: HYUNDAI MOTOR COMPANY, Seoul (KR); KIA MOTORS CORP., Seoul (KR); MYUNG HWA IND. CO., LTD., Seoul (KR)

(72) Inventors: Jung Hoon PARK, Anyang-si (KR); Kyoung Hee KIM, Ansan-si (KR); Jae Man CHO, Seoul (KR); Tae Sung OH, Ansan-si (KR); Geun Oh DONG, Hwaseong-si (KR)

(21) Appl. No.: 14/860,514

(22) Filed: Sep. 21, 2015

(30) Foreign Application Priority Data
Dec. 5, 2014 (KR) 10-2014-0174481

(51) Int. Cl. F02D 41/22; G01L 3/24; B60Q 9/00; F01P 5/10

(52) U.S. Cl. CPC F02D 41/221; F01P 5/10; G01L 3/242; B60Q 9/00; F02D 2041/228

(57) ABSTRACT

A method for diagnosing an electronic water pump of an engine in a vehicle includes determining whether a stall occurs while a sensorless 3-phase motor used for the electronic water pump of the engine is driven, based on a peak value of a torque of the motor. The method further includes determining whether the stall occurs while the motor is stopped, based on the torque of the motor.

### CROSS REFERENCE TO RELATED APPLICATION

The present application claims the benefit of priority to Korean Patent Application Number 10-2014-0174481 filed on Dec. 5, 2014, the entire contents of which application are incorporated herein for all purposes by reference.

### TECHNICAL FIELD

The present disclosure relates to a method of diagnosing an electronic water pump of an engine, and more particularly, to a technology of diagnosing a failure of an electronic water pump for circulating engine cooling water.

### BACKGROUND

An engine is configured to circulate cooling water using a water pump to cool heat generated from the engine. Typically, a crank shaft of the engine is generally equipped with a mechanical water pump mechanically interlocking therewith. In recent years, there has been a tendency to use an electronic water pump which may independently and actively control driving of a motor in consideration of various factors like an operation state of the engine, etc.

The above-mentioned electronic water pump is configured to be driven by an electric motor and therefore stably and appropriately operating the electric motor plays a crucial role in controlling a flow of engine cooling water.

Therefore, there is a need to configure the electronic water pump to diagnose a state of the motor forming the electronic water pump and appropriately cope with the state. In particular, it is very important to accurately diagnose a stall condition that even though a driving current is applied to the motor, the motor is not driven and thus the pumping of the cooling water is not actually made and appropriately cope with the stall condition.

Since an electronic water pump using a sensorless 3-phase motor as the motor used for the electronic water pump does not have a sensor sensing a rotating state of the motor, there is a need to prevent the engine from overheating by letting a controller appropriately sense the stall condition of the motor without the sensor.

The contents described as the related art have been provided only for assisting in the understanding for the background of the present invention and should not be considered as corresponding to the related art known to those skilled in the art.

### SUMMARY

An object of the present invention is to provide a method for diagnosing an electronic water pump of an engine capable of preventing a problem like engine overheat, etc., due to an inappropriate operation of the electronic water pump by letting a controller diagnose whether a mechanical stall condition occurs in a sensorless 3-phase motor used for the electronic water pump.

According to an exemplary embodiment of the present invention, there is provided a method for diagnosing an electronic water pump of an engine in a vehicle. The method includes: determining whether a stall occurs while a sensorless 3-phase motor used for the electronic water pump of the engine is driven, based on a peak value of a torque of the motor; and determining whether the stall occurs while the motor is stopped, based on the torque of the motor.

In certain embodiments, in the step of determining whether the stall occurs while the motor is driven, when a duty applied to the motor by a controller is greater than a first reference duty, a rotation speed of the motor is greater than a first reference rotation speed, and the peak value of the torque of the motor is greater than a first reference torque, it may be determined that the stall occurs while the motor is driven.

In certain embodiments, the first reference torque may be set to be a range from 1.5 times more than to 2 times less than a rated torque generated in a normal state of the motor.

In certain embodiments, in the step of determining whether the stall occurs while the motor is stopped, when a duty applied to the motor by a controller is greater than a second reference duty, a rotation speed of the motor is less than a second reference rotation speed, and the torque of the motor is greater than a second reference torque, it may be determined that the stall occurs while the motor is stopped.

In certain embodiments, the step of determining whether the stall occurs while the motor is stopped may be performed when a motor driving time lapses more than a first reference time after the motor starts to drive.

In certain embodiments, the first reference time may be set based on a time required to stably measure an RPM and the torque of the motor when the motor in the stopped state is normally driven and then accelerated, and the second reference rotation speed may be set to be smaller than a minimum RPM of the motor generated when the motor is normally driven more than the first reference time.

In certain embodiments, the steps of determining whether the stall occurs while the motor is driven and determining whether the stall occurs while the motor is stopped may be performed repeatedly to determine whether the stall continuously occurs more than a reference frequency.

In certain embodiments, when the stall continuously occurs more than the reference frequency, a warning may be issued to a driver of the vehicle or a driving mode of the vehicle may be limited.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow chart illustrating a method for diagnosing an electronic water pump of an engine according to an exemplary embodiment of the present invention.

### DETAILED DESCRIPTION

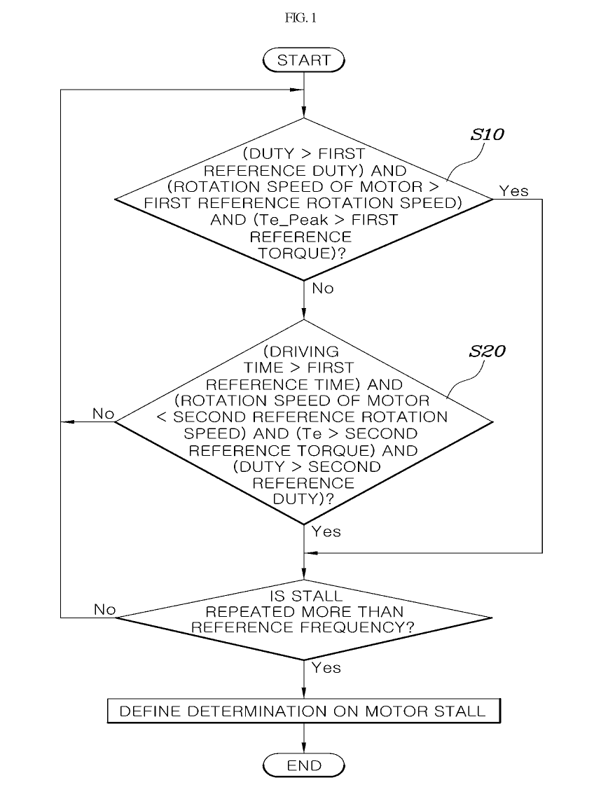

Referring to FIG. 1, a method for diagnosing an electronic water pump of an engine according to an exemplary embodiment of the present invention includes determining whether a stall occurs while a sensorless 3-phase motor used for the electronic water pump of the engine is driven, based on a peak value of a torque of the motor (S10) and determining whether the stall occurs while the motor is stopped, based on the torque of the motor (S20).

That is, according to the exemplary embodiment of the present invention, a controller of the motor may detect and determine whether the stall occurs in the sensorless 3-phase motor used for the electronic water pump of the engine, in the step of determining whether the stall occurs while the motor is driven (S10) and the step of determining whether the stall occurs while the motor is stopped (S20).

In the step of determining whether the stall occurs while the motor is driven (S10), when a duty applied by the controller to the motor is greater than a first reference duty, a rotation speed of the motor is greater than a first reference rotation speed, and a peak value Tₑ_{_}_{Peak} of the torque of the motor is greater than a first reference torque, it is determined that the stall occurs while the motor is driven. In certain embodiments, the first reference duty, the first reference rotation speed, and the first reference torque may be predetermined.

In certain embodiments, the first reference duty may be set to be a value of 20 to 30%. In certain embodiments, it may be set to be a duty at which the motor may be appropriately driven to some extent. In certain embodiments, the first reference rotation speed is set to be a value of 500 RPM or more. In certain embodiments, it may be set to be a level which may confirm the state in which the motor is certainly driven and thus is rotating. Further, in certain embodiments, the first reference torque may be set to be a range from 1.5 times more than to 2 times less than a rated torque which is generally generated in a normal state of the motor.

That is, in certain embodiments, the duty having the value of 20 to 30% may be applied to the motor to appropriately drive the motor, and thus the motor rotates in the state in which the speed of the motor exceeds, for example, 500 RPM. A sudden increase in the torque of the motor to 1.5 times greater than the rated torque during the rotation of the motor may be caused by foreign materials suddenly involved in the motor and thus the rotation of the motor is mechanically suppressed to cause the stall condition. For reference, in certain embodiments, the sensorless 3-phase motor used in the present invention is configured to be controlled by a sensorless field oriented control (FOC) scheme.

In certain embodiments, in the step of determining whether the stall occurs while the motor is stopped (S20), when the duty applied from the controller to the motor is greater than a second reference duty, the rotation speed of the motor is less than a second reference rotation speed, and the torque of the motor is greater than a second reference torque, it is determined that the stall occurs while the motor is stopped. In certain embodiments, the second reference duty, the second reference rotation speed, and the second reference torque may be predetermined.

In certain embodiments, the step of determining whether the stall occurs while the motor is stopped (S20) is performed when a motor driving time lapses more than a first reference time after the motor starts to drive.

In certain embodiments, the first reference time is set based on a time required to stably measure the RPM and the torque of the motor when the motor in the stopped state is normally driven and then accelerated and the second reference rotation speed may be set to be smaller than a minimum RPM of the motor which may be generated when the motor is normally driven more than the first reference time.

That is, in certain embodiments, the first reference time may be set as, for example, 0.3 seconds. Here, in spite of accelerating the motor for the set time, if the rotation speed of the motor is less than the second reference rotation speed (for example, 500 RPM), it may be estimated that the motor once in the stopped state is in a stall condition. In this case, the duty applied to the motor needs to be set to an appropriate value of a level which may appropriately drive the motor and therefore the second reference duty may also be determined to be a range from 20% to 30%.

Meanwhile, in certain embodiments, in the step of determining whether the stall occurs while the motor is stopped (S20), as described above, the torque Te of the motor is compared with the second reference torque. As the comparison result, in certain embodiments, if the motor is in the normal state, the second reference torque is determined to be a value greater than a torque calculated from a current applied to the motor so as to be in proportion to the RPM and a load of the motor. For example, in certain embodiments, if the normal torque calculated from the current applied to the motor depending on the current RPM and load of the motor is 0.15 Nm, the second reference torque is set to be about 0.2 Nm.

Therefore, in certain embodiments, in the step of determining whether the stall occurs while the motor is stopped (S20), it is determined that even though the motor is driven at the duty greater than the second reference duty for the first reference time or more so as to appropriately drive the motor in the stop state, the motor rotates little in the state in which the speed of the motor is less than the second reference speed and if the torque Te of the motor which is a torque (current) 30% greater than the normal torque depending on the RPM and the load of the motor is applied to the motor, the motor in the stop state is in the stall state and therefore even though the greater driving duty is applied to the motor, the driving of the electronic water pump is impossible.

Meanwhile, according to an exemplary embodiment of the present invention, when the step of determining whether the stall occurs while the motor is driven (S10) and the step of determining whether the stall occurs while the motor is stopped (S20) are repeatedly performed multiple times to determine that the stall continuously occurs more than a reference frequency, the determination of whether the stall occurs is considered definite, thereby more stably and accurately determining the stall.

For example, in certain embodiments, when the same determination is continuously performed tens of times like the reference frequency of 20 times to 50 times, etc., the determination is definite that the motor is stalled, such that separate actions to issue a warning to a driver, limit a driving mode of a vehicle, and the like may be taken.

According to the exemplary embodiments of the present invention, it is possible to prevent the problem like the engine overheat, etc., due to the inappropriate operation of the electronic water pump by letting the controller diagnose whether the mechanical stall condition occurs in the sensorless 3-phase motor used for the electronic water pump.

Although the present invention has been shown and described with respect to specific exemplary embodiments, it will be obvious to those skilled in the art that the present invention may be variously modified and altered without departing from the spirit and scope of the present invention as defined by the following claims.

What is claimed is:

1. A method of diagnosing an electronic water pump of an engine in a vehicle, the method comprising:
determining whether a stall occurs while a sensorless 3-phase motor used for the electronic water pump of the engine is driven, based on a peak value of a torque of the motor; and
determining whether the stall occurs while the motor is stopped, based on the torque of the motor.

2. The method of claim 1, wherein in the step of determining whether the stall occurs while the motor is driven, when a duty applied to the motor by a controller is greater than a first reference duty, a rotation speed of the motor is greater than a first reference rotation speed, and the peak value of the torque of the motor is greater than a first reference torque, it is determined that the stall occurs while the motor is driven.

3. The method of claim 2, wherein the first reference torque is set to be a range from 1.5 times more than to 2 times less than a rated torque generated in a normal state of the motor.

4. The method of claim 1, wherein in the step of determining whether the stall occurs while the motor is stopped, when a duty applied to the motor by a controller is greater than a second reference duty, a rotation speed of the motor is less than a second reference rotation speed, and the torque of the motor is greater than a second reference torque, it is determined that the stall occurs while the motor is stopped.

5. The method of claim 4, wherein the step of determining whether the stall occurs while the motor is stopped is performed when a motor driving time lapses more than a first reference time after the motor starts to drive.

6. The method of claim 5, wherein the first reference time is set based on a time required to stably measure an RPM and the torque of the motor when the motor in the stopped state is normally driven and then accelerated, and
the second reference rotation speed is set to be smaller than a minimum RPM of the motor generated when the motor is normally driven more than the first reference time.

7. The method of claim 1, wherein the steps of determining whether the stall occurs while the motor is driven and determining whether the stall occurs while the motor is stopped are performed repeatedly to determine whether the stall continuously occurs more than a reference frequency.

8. The method of claim 7, wherein when the stall continuously occurs more than the reference frequency, a warning is issued to a driver of the vehicle or a driving mode of the vehicle is limited.
